(19) United States
(12) Patent Application Publication
(10) Pub. No.: US 2003/0015335 A1
(43) Pub. Date: Jan. 23, 2003

(54) Terminal structure of wire winding rack

(76) Inventor: Chung Yu Lin, Taipei (TW)

Correspondence Address: Keith Kline, PRO-TECHTOR INTERNATIONAL SERVICES, 20775 Norada Court, Saratoga, CA, 95070-3018, US

(21) Appl. No.: 09/908,041

(22) Filed: Jul. 17, 2001

(51) Int. Cl. H02G 3/08

(52) U.S. Cl. 174/52.1

(57) ABSTRACT

The present invention is to provide a terminal structure of a wire winding rack. The wire winding rack has two ends respectively provided with multiple terminals. Each of the terminals has an insertion end formed with a substantially T-shaped hook for increasing a contact area between each terminal and the wire winding rack, so that the terminal is combined with the wire winding rack rigidly and stably, thereby increasing the strength of the combination of the terminal and the wire winding rack, so that the terminal cannot be detached from the wire winding rack.

### BACKGROUND OF THE INVENTION

1. Field of the Invention

The present invention relates to a terminal structure of a wire winding rack of SMD, and more particularly to a terminal having a hook, wherein the terminal may be combined with the wire winding rack rigidly and stably, thereby increasing the strength of the combination of the terminal and the wire winding rack, so that the terminal cannot be detached from the wire winding rack.

2. Description of the Related Art

The product of SMD may be broadly utilized in an equipment such as a computer, a transformer or the like. A miniature transformer comprises a wire winding rack of SMD. The wire winding rack has two ends respectively provided with multiple terminals. Each of the terminals may be mounted on the wire winding rack by a high frequency wave or an injection molding process.

A conventional terminal 200 in accordance with the prior art shown in FIG. 4 has a flat structure. Thus, the contact area between the terminal 200 and the wire winding rack is small, so that the terminal 200 is not combined with the wire winding rack rigidly and stably, thereby decreasing the strength of the combination of the terminal 200 and the wire winding rack, so that the terminal 200 is easily detached from the wire winding rack, thereby affecting the quality of the product of SMD.

### SUMMARY OF THE INVENTION

The present invention has arisen to mitigate and/or obviate the disadvantage of the conventional terminal of a wire winding rack of SMD.

The primary objective of the present invention is to provide a terminal structure of a wire winding rack including a terminal having a hook so as to increase the strength of the combination of the terminal and the wire winding rack.

In accordance with the present invention, there is provided a terminal structure of a wire winding rack, the wire winding rack having two ends respectively provided with multiple terminals;

wherein, each of the terminals has an insertion end formed with a hook for increasing a contact area between each the terminal and the wire winding rack, so that the terminal is combined with the wire winding rack rigidly and stably, thereby increasing a strength of a combination of the terminal and the wire winding rack, so that the terminal cannot be detached from the wire winding rack.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a terminal structure of a wire winding rack in accordance with the present invention;

FIG. 2 is a plan view of a terminal structure of a wire winding rack in accordance with the present invention;

FIG. 3 is a plan view of the terminal in accordance with the present invention; and

FIG. 4 is a plan view of a conventional terminal in accordance with the prior art.

### DETAILED DESCRIPTION OF THE INVENTION

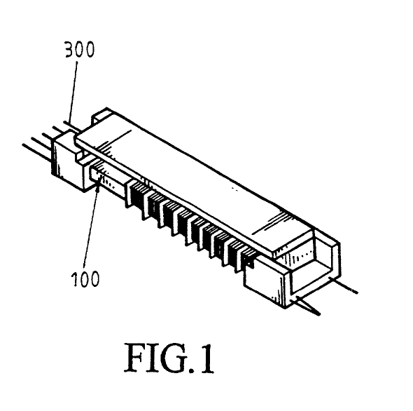

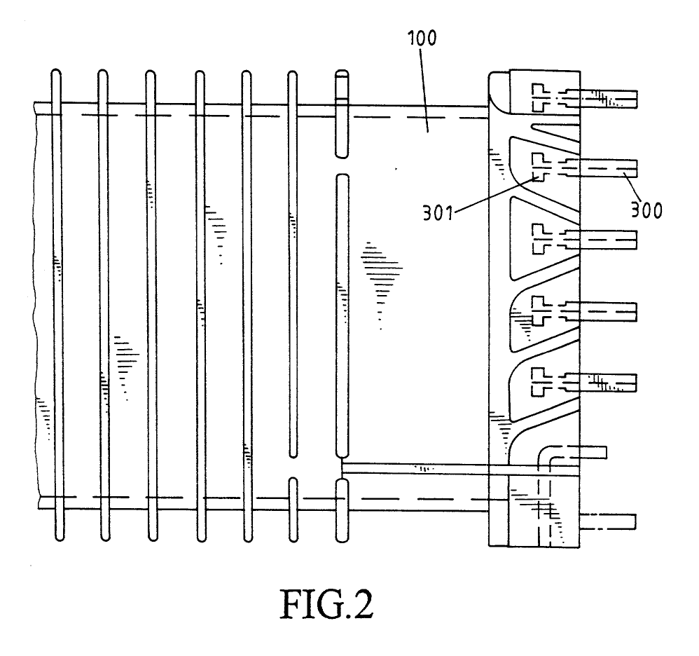

Referring to the drawings and initially to FIGS. 1 and 2, a wire winding rack 100 of SMD in accordance with the present invention may be used in a miniature transformer, and has two ends respectively provided with multiple terminals (or connecting legs) 300. Each of the terminals 300 may be fixed on the wire winding rack 100 by a high frequency wave or an injection molding process.

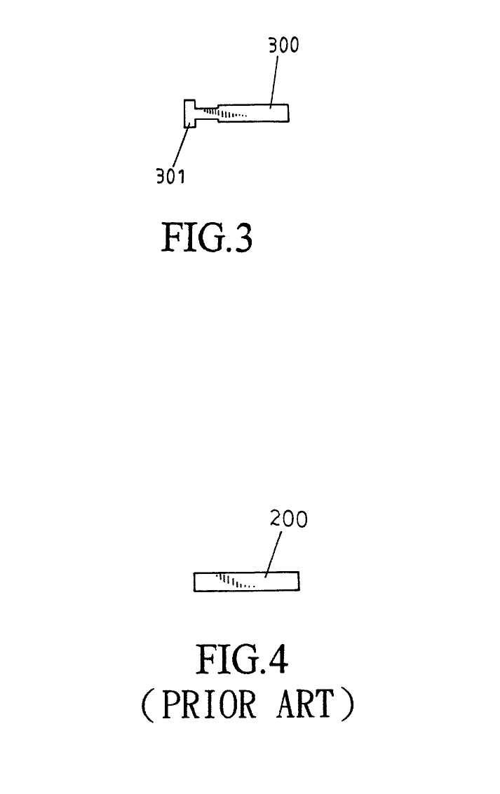

Referring to FIG. 3, each terminal 300 has an insertion end formed with a substantially T-shaped hook 301. The T-shaped hook 301 may increase the contact area between the terminal 300 and the wire winding rack 100, so that the terminal 300 may be combined with the wire winding rack 100 rigidly and stably, thereby increasing the strength of the combination of the terminal 300 and the wire winding rack 100, so that the terminal 300 cannot be detached from the wire winding rack 100 easily.

Alternatively, the hook 301 may be designed to have various arc-shaped configurations.

Accordingly, the terminal structure of the wire winding rack of SMD in accordance with the present invention includes a terminal having a hook. The terminal may be combined with the wire winding rack rigidly and stably by means of the hook, thereby increasing the strength of the combination of the terminal and the wire winding rack, so that the terminal structure of the wire winding rack of SMD may withstand a greater outward pulling force. Thus, the terminal cannot be detached from the wire winding rack easily.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A terminal structure of a wire winding rack, said wire winding rack having two ends respectively provided with multiple terminals;
wherein, each of said terminals has an insertion end formed with a hook for increasing a contact area between each said terminal and said wire winding rack, so that said terminal is combined with said wire winding rack rigidly and stably, thereby increasing a strength of a combination of said terminal and said wire winding rack, so that said terminal cannot be detached from said wire winding rack.

2. The terminal structure of a wire winding rack in accordance with claim 1, wherein said hook of each said terminal is substantially T-shaped.
